(19) United States
(12) Patent Application Publication
(10) Pub. No.: US 2007/0129525 A1
(43) Pub. Date: Jun. 7, 2007

(54) METHOD FOR PRODUCING POLYURETHANE PREPOLYMERS

(76) Inventors: Holger Eichelmann, Duesseldorf (DE); Hans-Georg Kinzelmann, Pulheim (DE); Marion Wortmann, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 11/539,728

(22) Filed: Oct. 9, 2006

Related U.S. Application Data
(63) Continuation of application No. PCT/EP05/02205, filed on Mar. 3, 2005.

(30) Foreign Application Priority Data
Apr. 8, 2004 (DE) 10 2004 018 048.2

(51) Int. Cl. C08G 18/00

(52) U.S. Cl. 528/44

(57) ABSTRACT

The invention relates to a process for preparing a polyurethane prepolymer having terminal isocyanate groups by reacting polyisocyanates with polyols. The process includes a first synthesis stage and a second synthesis stage. A component (A) is prepared in the first synthesis stage using as polyisocyanate (X) at least one asymmetric polyisocyanate and using as polyol at least one polyol having an average molecular weight (Mₙ) of 60 to 3000 g/mol, with the ratio of hydroxyl groups to isocyanate groups being less than 1. In the second synthesis stage, a further polyol is added to component (A), the reaction ratio of the hydroxyl groups of the further polyol to isocyanate groups of component A being set in the range from 1.1:1 to 2.0:1.

### CROSS-REFERENCE TO RELATED APPLICATIONS

This application is a continuation under 35 USC Sections 365(c) and 120 of International Application No. PCT/EP2005/002205 filed 3 Mar. 2005 and published 20 Oct. 2005 as WO 2005/097861, which claims priority from German Application No. 102004018048.2, filed 8 Apr. 2004, each of which is incorporated herein by reference in its entirety.

### FIELD OF THE INVENTION

The present invention relates to a process for preparing polyurethane prepolymers having terminal isocyanate groups by staged reaction of polyisocyanates with polyols, and also to their use.

### DISCUSSION OF THE RELATED ART

Polyurethane prepolymers which have terminal isocyanate groups and are prepared by staged reaction of polyisocyanates with polyols are known. With suitable curing agents—generally polyfunctional alcohols—they can be reacted to form higher molecular weight polymers. Polyurethane prepolymers have acquired importance in numerous fields of application, including sealants, paints, and adhesives, for instance.

EP 0150444 describes a process for preparing polyurethane prepolymers having terminal isocyanate groups from diisocyanates of different reactivity and polyfunctional alcohols, comprising a first reaction step of reacting the diisocyanates having NCO groups of different reactivity with polyfunctional alcohols in an OH:NCO ratio of between 4 and 0.55 and, following the consumption by reaction of virtually all rapid NCO groups with a fraction of the OH groups present, a second reaction step of adding equimolar or excess amounts—relative to remaining free OH groups—of a diisocyanate which is more reactive as compared with the less reactive NCO groups of the isocyanate from reaction step 1.

EP 0118065 describes a process for preparing polyurethane prepolymers having terminal isocyanate groups from monocyclic and dicyclic diisocyanates, comprising a first stage of reacting a monocyclic diisocyanate with a polyfunctional alcohol in an OH group:NCO group ratio of less than 1 and, in the prepolymer thus formed, reacting a dicyclic diisocyanate with polyfunctional alcohols in an OH group:NCO group ratio of less than 1. The OH group:NCO group ratio in the case of the first reaction is situated in particular at between 0.4 and 0.8.

WO 98/29466 describes a process for preparing a low monomer content PU prepolymer having free NCO groups, comprising a first reaction step of reacting a diisocyanate having NCO groups of different reactivity (asymmetric diisocyanate) with polyfunctional alcohols in an OH:NCO ratio between 4 and 0.55 and, following the consumption by reaction of virtually all of the rapid NCO groups with a fraction of the OH groups present, a second reaction step of adding a substoichiometric amount, relative to remaining free OH groups, of a diisocyanate (symmetric diisocyanate) which is more reactive as compared with to the less reactive NCO groups of the isocyanate from reaction step 1.

WO 99/24486 describes a process for preparing a low-viscosity polyurethane binder which carries isocyanate groups, said process comprising at least two stages, a first stage comprising preparation of a polyurethane prepolymer from an at least difunctional isocyanate and at least one polyol component and the second stage comprising reaction of a further at least difunctional isocyanate or a further at least difunctional isocyanate and a further polyol component in the presence of the polyurethane prepolymer, the predominant proportion of the isocyanate groups that are present after the end of the first stage having a lower reactivity toward isocyanate-reactive groups, especially toward OH groups, than the isocyanate groups of the at least difunctional isocyanate added in the second stage, and the OH:NCO ratio in the second stage being 0.2 to 0.6. In the first stage the OH:NCO ratio is less than 1, in particular 0.4 to 0.7.

Some of the polyurethane prepolymers known from the prior art already contain less than 0.1% by weight of monomeric, readily volatile diisocyanates, especially free TDI, and so make it unnecessary for the user to install costly suction withdrawal apparatus in order to keep the air clean. The amount of 4,4′-MDI, however, is generally well above 0.1% by weight. Systems of this kind fall within hazardous substances regulations and are subject to labeling accordingly. The labeling obligation goes hand in hand with special measures for packaging and for transport.

In addition, some of the known polyurethane prepolymers are not entirely migration-free. The concept of migration comprehends the wandering of low molecular weight compounds from the polyurethane prepolymers or the polyurethane prepolymer based systems into the ambient environment. Entities considered principal causative agents for the migration are primarily the monomeric diisocyanates, which are generally of low volatility. The migration of monomeric diisocyanates of this kind may result in production defects, an example being a reduced sealed seam strength in laminates. Furthermore, migratable compounds or their breakdown products may give rise to a health hazard, with the consequence that increased storage times and more in-depth monitoring are needed until the product is free from migrant material, particularly in the case of products which are subject to contact with comestibles. Furthermore, the known polyurethane prepolymers are often of high viscosity, and in certain circumstances this may result in processing difficulties, particularly in the context of solvent-free film lamination.

Within the industry, therefore, there continues to be a desire for polyurethane prepolymers which as far as possible contain no free TDI and/or MDI monomers and which permit the provision of adhesives having a very low processing viscosity. As far as possible they ought not to contain any volatile or migrant substances nor release such substances into the ambient environment. Inconvenient, high-cost purification steps for the purpose of attaining freedom from monomer ought where possible to be avoided. Another requirement imposed on polyurethanes of this kind is that, directly after application to at least one of the materials to be joined, and after the joining of those materials, the polyurethanes are to exhibit sufficiently good initial adhesion, preventing the composite material separating into its original components and, as far as possible, preventing the bonded materials from shifting relative to one another. Furthermore, however, an adhesive bond of this kind should also possess a sufficient degree of flexibility to withstand the various tensile and stretching loads to which the composite material is generally subject whilst still in its processing state, and to do so without damage for the adhesive bond and without damage for the bonded material.

### BRIEF SUMMARY OF THE INVENTION

The present invention provides a process for preparing polyurethane prepolymers having terminal isocyanate groups which comprises reacting polyisocyanates with polyols, wherein
(I) in a first synthesis stage a component (A) is prepared by
   a) using as polyisocyanate (X) at least one asymmetric polyisocyanate preferably from the group of tolylene diisocyanate (TDI) having a 2,4-TDI content ≧99% by weight and diphenylmethane 2,4′-diisocyanate (MDI) having a 2,4′ isomer fraction of at least 95% by weight, preferably at least 97% by weight;
   b) using as polyol at least one polyol having an average molecular weight (Mₙ) of 60 to 3000 g/mol;
   c) setting the ratio of hydroxyl groups to isocyanate groups <1, preferably in the range between 0.4:1 to 0.8:1, with particular preference in the range between 0.45:1 to 0.6:1;
   d) adding, where appropriate, a catalyst, and, following the reaction of all of the hydroxyl groups;
(II) in a second synthesis stage a further polyol is added to component (A), the reaction ratio of the hydroxyl groups of the further polyol to isocyanate groups of component A being set in the range from 1.1:1 to 2.0:1, preferably 1.3:1 to 1.8:1, and with particular preference in the range from 1.45:1 to 1.75:1.

Preferably, in a third synthesis stage, at least one further at least difunctional polyisocyanate, with particular preference one further at least trifunctional polyisocyanate, is added.

### DETAILED DESCRIPTION OF CERTAIN EMBODIMENTS OF THE INVENTION

The polyurethane prepolymers having terminal isocyanate groups that are prepared by the process of the invention are of low monomer content.

By “low monomer content” is meant a low concentration of the asymmetric starting polyisocyanates, particularly the starting polyisocyanates of the first synthesis stage, such as 2,4-TDI′, 2,4′-MDI′ or TMXDI, in the inventively prepared polyurethane prepolymer.

The inventively prepared polyurethane prepolymers are solvent-free or contain solvent.

The monomer concentration is below 1%, preferably below 0.5%, in particular below 0.3%, and with particular preference below 0.1% by weight, based on the total weight of the solvent-free or solvent-containing polyurethane prepolymer of the invention having terminal isocyanate groups. The weight fraction of the monomeric diisocyanate is determined gas-chromatographically (GC), by means of high-performance liquid chromatography (HPLC) or by means of gel permeation chromatography (GPC).

The polyurethane prepolymers having terminal isocyanate groups that are prepared by the process of the invention are notable in particular for a low viscosity. Thus the inventively prepared polyurethane prepolymers having terminal NCO groups have at 40° C. a viscosity of 800 mPas to 10 000 mPas, preferably of 1000 mPas to 5000 mPas, and with particular preference of 1200 mPas to 3000 mPas (measured by the Brookfield method, ISO 2555).

Polyurethane prepolymers of this kind are sufficiently liquid at room temperature to allow further processing. They can be used advantageously at temperatures of 25 to 100° C., preferably of 35 to 75° C., and with particular preference of 40 to 55° C., for adhesively bonding temperature-sensitive substrates, especially polyolefin films.

The inventively prepared polyurethane prepolymers having terminal isocyanate groups are particularly suitable as a resin component in two-component (2K) adhesives. Curing components used are oligomeric or polymeric compounds which have at least two groups that are reactive toward isocyanate groups, these reactive groups being, in particular, hydroxyl groups. The corresponding 2K adhesives are notable for very short cure times with respect to the migration of monomeric diisocyanates, especially monomeric aromatic diisocyanates, and/or corresponding amines, since the terminal isocyanate groups of the polyurethane prepolymer of the invention react rapidly and almost completely with the curing component.

The molecular weight figures which refer in the text below to polymeric compounds are references, unless indicated otherwise, to the number average of the molecular weight (Mₙ). All molecular weight figures relate, unless indicated otherwise, to values of the kind obtainable by gel permeation chromatography (GPC).

Tolylene diisocyanate (TDI) is well established. It is prepared by nitrating toluene, reducing and reacting the resultant toluenediamines with phosgene or directly from dinitrotoluenes and carbon monoxide. The industrially most important diisocyanates, 2,4-TDI and 2,6-TDI, are employed as a mixture in a 2,4-TDI to 2,6-TDI isomer ratio of 80:20 and, less often, in an isomer ratio of 65:35 for the purpose of preparing polyurethanes. Tolylene diisocyanate is available commercially under the designations TDI-65, TDI-80 and TDI-100, an example being Desmodur® T100 from Bayer; the numbers there denote the amount in % of more reactive 2,4 isomer as compared with the less reactive 2,6 isomer. TDI is used in particular for producing flexible polyurethane foams. In the case of reactive adhesive systems it plays more of a minor part, since as compared with MDI (methylenebisphenyl diisocyanate) it possesses a high vapor pressure. MDI with a 2,4′ isomer fraction of at least 97.5% by weight is available for example from Elastogran under the trade name Lupranat® MCI.

In the process of the invention the polyisocyanate (X) used is at least one asymmetric polyisocyanate preferably from the group of tolylene diisocyanate (TDI) having a 2,4-TDI and 2,4′-MDI content ≧99% by weight, with a 2,4′ isomer fraction of at least 95% by weight, preferably at least 97.5% by weight.

When selecting the polyisocyanates for the first synthesis stage it should be borne in mind that the NCO groups of the polyisocyanates must possess different reactivity with respect to compounds which carry isocyanate-reactive functional groups. This applies in particular to diisocyanates having NCO groups in a different chemical environment, i.e., to asymmetric diisocyanates. It is known that dicyclic diisocyanates or, generally, symmetric diisocyanates have a higher reaction rate than the second isocyanate group of asymmetric or monocyclic diisocyanates.

The asymmetric diisocyanate is selected from the group of aromatic, aliphatic or cycloaliphatic diisocyanates. From the group of aromatic diisocyanates having NCO groups of different reactivity the polyisocyanate is preferably selected from the following group: all isomers of tolylene diisocyanate (TDI), either in isomerically pure form or as a mixture of two or more isomers, naphthalene 1,5-diisocyanate (NDI), phenylene 1,3-diisocyanate and or dimethylmethane 2,4′-diisocyanate (2,4′-MDI). Particular preference is given to 2,4′-MDI with a purity of >97% by weight in terms of 2,4-MDI. Preferred aliphatic diisocyanates having NCO groups of different reactivity are 1,6-diisocyanato-2,2,4-trimethylhexane, 1,6-diisocyanato-2,4,4-trimethylhexane, and lysine diisocyanate.

Preferred cycloaliphatic diisocyanates having NCO groups of different reactivity are, for example, 1-isocyanatomethyl-3-isocyanato-1,5,5-trimethylcyclohexane (isophorone diisocyanate, IPDI) and 1-methyl-2,4-diisocyanatocyclohexane.

By the feature “polyisocyanate” is meant a compound having two or more isocyanate groups. A difunctional polyisocyanate possesses two free NCO groups; a trifunctional polyisocyanate, accordingly, possesses three free NCO groups. Preferably, in a third synthesis stage, at least one further at least difunctional polyisocyanate is added. As a difunctional polyisocyanate a polyisocyanate having the general structure O═C═N—Y—N═C═O is used, Y being an aliphatic, alicyclic or aromatic radical, preferably an alicyclic or aromatic radical having 4 to 18 C atoms.

Suitable polyisocyanates are selected from the following group: naphthylene 1,5-diisocyanate, diphenylmethane 2,4- or 4,4′-diisocyanate (MDI), hydrogenated MDI (H₁₂MDI), xylylene diisocyanate (XDI), tetramethylxylylene diisocyanate (TMXDI), diphenyldimethylmethane 4,4′-diisocyanate, di- and tetraalkylenediphenylmethane diisocyanate, bibenzyl 4,4′-diisocyanate, phenylene 1,3-diisocyanate, phenylene 1,4-diisocyanate, the isomers of tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanato-3-isocyanato-1,5,5-trimethylcyclohexane (IPDI), chlorinated and brominated diisocyanates, phosphorus-containing diisocyanates, 4,4′-diisocyanatophenylperfluoroethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, bisisocyanatoethyl phthalate, and also diisocyanates containing reactive halogen atoms, such as 1-chloromethylphenyl 2,4-diisocyanate, 1-bromomethylphenyl 2,6-diisocyanate, and 3,3-bischloromethyl ether-biphenyl 4,4′-diisocyanate. From the group of the aromatic polyisocyanates, in one preferred embodiment of the process of the invention, methylenetriphenyl triisocyanate (MIT) is used in the third synthesis stage. Aromatic diisocyanates are defined in that the isocyanate group is disposed directly on the benzene ring. Aromatic diisocyanates which can be used are diphenylmethane 2,4- or 4,4′-diisocyanate (MDI), the isomers of tolylene diisocyanate (TDI), and naphthalene 1,5-diisocyanate (NDI). Sulfur-containing polyisocyanates are obtained by, for example, reacting 2 mol of hexamethylene diisocyanate with 1 mol of thiodiglycol or dihydroxydihexyl sulfide. Further diisocyanates which can be used are trimethylhexamethylene diisocyanate, 1,4-diisocyanatobutane, 1,12-diisocyanatododecane, and dimer fatty acid diisocyanate. Particularly suitable candidates include the following: tetramethylene, hexamethylene, undecane, dodecamethylene, 2,2,4-trimethylhexane-2,3,3-trimethylhexamethylene, cyclohexane 1,3-, cyclohexane 1,4-, tetramethylxylene 1,3- or 1,4-, isophorone, dicyclohexylmethane 4,4-, tetramethylxylylene (TMXDI), and lysine ester diisocyanate. Suitable at least trifunctional isocyanates are polyisocyanates which are formed by trimerizing or oligomerizing diisocyanates or by reacting diisocyanates with polyfunctional compounds containing hydroxy or amino groups.

Isocyanates suitable for preparing trimers are the diisocyanates already stated above, particular preference being given to the trimerization products of the isocyanates HDI, MDI or IPDI. Additionally suitable are blocked, reversibly capped polykisisocyanates such as 1,3,5-tris[6-(1-methylpropylideneaminoxycarbonylamino)hexyl]-2,4,6-trixo-hexahydro-1,3,5-triazine.

Likewise suitable for use are the polymeric isocyanates of the kind obtained, for example, as a residue in the liquid phase of the distillation of diisocyanates. Particularly suitable in this context is the polymeric MDI of the kind obtainable from the distillation residue in the distillation of MDI.

In one preferred embodiment of the invention DESMODUR N 3300, DESMODUR N 100 (manufacturer: Bayer AG) or the IPDI trimer isocyanurate T 1890 (manufacturer: Degussa) is used in the third stage.

In a further preferred embodiment of the invention a triisocyanate is used as further polyisocyanate in the third reaction stage. Preferred triisocyanates are adducts of diisocyanates and low molecular weight triols, especially the adducts of aromatic diisocyanates and triols, such as trimethylolpropane or glycerol, for example. Aliphatic triisocyanates as well, such as, for example, the biuretization product of hexamethylene diisocyanate (HDI) or the isocyanuratization product of HDI, or else the same trimerization products of isophorone diisocyanate (IPDI), are suitable for the polyurethane prepolymers of the invention, provided the diisocyanate fraction is <1% by weight and the tetrafunctional and higher polyfunctional isocyanate fraction is not greater than 25% by weight. On account of their ready availability the aforementioned trimerization products of HDI and of IPDI are particularly preferred in this context.

In one particularly preferred embodiment of the process of the invention, in the third synthesis stage, as further polyisocyanate, a mixture of a diisocyanate, preferably an aromatic diisocyanate, with carbodiimide is used. Carbodiimide groups are obtainable in a simple way from two isocyanate groups with elimination of carbon dioxide. Starting from diisocyanates it is possible in this way to obtain oligomeric compounds with two or more carbodiimide groups and preferably terminal isocyanate groups. Oligomeric carbodiimides and their preparation are described in WO 03/068703 on page 3 line 37 to page 5 line 41. In the mixture of diisocyanate and carbodiimide the diisocyanate is present at 5% to 95% by weight, preferably at 20% to 90% by weight, and with particular preference at 40% to 85% by weight, based on the total weight of the mixture. Commercially available mixtures of diisocyanate and carbodiimide are available, for example, under the trade name Isonate® 143 L or M from Dow Chemical Company, DESMODUR CD from Bayer AG, or as SUPRASEC 2020 from Hunstman.

It is important in the first synthesis stage to use as polyisocyanate (X) an asymmetric polyisocyanate, preferably from the group of: TDI having a 2,4-TDI content ≧99% by weight and diphenylmethane 2,4-diisocyanate having a 2,4′ isomer fraction of at least 95% by weight, preferably at least 97.5% by weight, and to initiate the 2nd synthesis stage only when all of the hydroxyl groups have reacted. In spite of the high reactivity, particularly of the 2,4-TDI and 24′-MDI isomer, the reaction, surprisingly, proceeds very selectively under the reaction conditions indicated, particularly in the selected OH:NCO reaction ratio range, and results in component (A) having a low viscosity and a very low monomeric polyisocyanate (X) content by the end of just the first process stage.

The term “polyol” embraces for the purposes of the present text a single polyol or a mixture of two or more polyols which can be employed for preparing polyurethanes. By a polyol is meant a polyfunctional alcohol, i.e., a compound having more than one OH group in the molecule.

Suitable polyols are aliphatic alcohols having 2 to 6, preferably 2 to 4, OH groups per molecule. The OH groups may be both primary and secondary.

The suitable aliphatic alcohols include, for example, ethylene glycol, propylene glycol, butane-1,4-diol, pentane-1,5-diol, hexane-1,6-diol, heptane-1,7-diol, octane-1,8-diol and their higher homologs or isomers of the kind which arise for the skilled worker from a stepwise extension of the hydrocarbon chain by one CH₂ group in each case, or with introduction of branching points into the carbon chain. Likewise suitable are higher polyfunctional alcohols such as, for example, glycerol, trimethylolpropane, pentaerythritol and also oligomeric ethers of the stated substances with themselves or in a mixture of two or more of the stated ethers with one another. Preference is given to using as the polyol component reaction products of low molecular weight polyfunctional alcohols with alkylene oxides, known as polyethers. The alkylene oxides preferably have 2 to 4 C atoms. Suitable examples are the reaction products of ethylene glycol, propylene glycol, the isomeric butanediols, hexanediols or 4,4′-dihydroxydiphenylpropane with ethylene oxide, propylene oxide or butylene oxide, or mixtures of two or more thereof. Also suitable, furthermore, are the reaction products of polyfunctional alcohols, such as glycerol, trimethylolethane or trimethylolpropane, pentaerythritol or sugar alcohols, or mixtures of two or more thereof, with the stated alkylene oxides to form polyether polyols.

Thus it is possible—depending on the desired molecular weight—to use adducts of just a few moles of ethylene oxide and/or propylene oxide per mole, or else of more than one hundred moles of ethylene oxide and/or propylene oxide with low molecular weight polyfunctional alcohols. Further polyether polyols are preparable by condensing, for example, glycerol or pentaerythritol with elimination of water.

Further polyols customary in the context of the invention are formed, moreover, by polymerization of tetrahydrofuran (polyTHF).

Among the stated polyether polyols the reaction products of polyfunctional low molecular weight alcohols with propylene oxide under conditions in which there is at least partial formation of secondary hydroxyl groups are particularly suitable, especially for the first synthesis stage. The polyether polyols are reacted in a way which is known to the skilled person, by reaction of the starter compound, having a reactive hydrogen atom, with alkylene oxides, examples being ethylene oxide, propylene oxide, butylene oxide, styrene oxide, tetrahydrofuran or epichlorohydrin, or mixtures of two or more thereof. Examples of suitable starter compounds include water, ethylene glycol, propylene 1,2-glycol or 1,3-glycol, butylene 1,4-glycol or 1,3-glycol, hexane-1,6-diol, octane-1,8-diol, neopentyl glycol, 1,4-hydoxymethylcyclohexane, 2-methyl-1,3-propanediol, glycerol, trimethylolpropane, hexane-1,2,6-triol, butane-1,2,4-triol, trimethylolethane, pentaerythritol, mannitol, sorbitol, methylglycosides, sugars, phenol, isononylphenol, resorcinol, hydroquinone, 1,2,2- or 1,1,2-tris(hydroxyphenyl)ethane, ammonia, methylamine, ethylene-diamine, tetra- or hexamethylenamine, triethanolamine, aniline, phenylenediamine, 2,4- and 2,6-diaminotoluene, and polyphenylpolymethylenepolyamines of the kind obtainable by aniline-formaldehyde condensation, or mixtures of two or more thereof.

Likewise suitable for use as polyol components are polyethers which have been modified by means of vinyl polymers. Products of this kind are obtainable, for example, by polymerizing styrene- or acrylonitrile, or a mixture thereof, in the presence of polyethers.

As polyol it is preferred to use at least one polyester polyol.

Suitable polyester polyols are those formed by reaction of low molecular weight alcohols, in particular of ethylene glycol, diethylene glycol, neopentyl glycol, hexanediol, butanediol, propylene glycol, glycerol or trimethylolpropane, with caprolactone.

Further suitable polyester polyols are preparable preferably by polycondensation. Polyester polyols of this kind preferably comprise the reaction products of polyfunctional, preferably difunctional alcohols (together where appropriate with small amounts of trifunctional alcohols) and polyfunctional, preferably difunctional and/or trifunctional carboxylic acids. Instead of free polycarboxylic acids, the corresponding polycarboxylic anhydrides or corresponding polycarboxylic esters with alcohols having preferably 1 to 3 C atoms can also be used (if possible). Suitable for the preparation of such polyester polyols are, in particular, hexanediol, 1,4-hydroxymethylcyclohexane, 2-methyl-1,3-propanediol, butane-1,2,4-triol, triethylene glycol, tetraethylene glycol, ethylene glycol, polyethylene glycol, dipropylene glycol, polypropylene glycol, dibutylene glycol and polybutylene glycol.

The polycarboxylic acids may be aliphatic, cycloaliphatic, aromatic or heterocyclic or both. They may, where appropriate, be substituted, by alkyl groups, alkenyl groups, ether groups or halogens, for example. Examples of suitable polycarboxylic acids include succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene-tetrahydrophthalic anhydride, glutaric anhydride, maleic acid, maleic anhydride, fumaric acid, dimer fatty acid or trimer fatty acid, or mixtures of two or more thereof. Where appropriate it is possible for minor amounts of monofunctional fatty acids to be present in the reaction mixture.

Suitable tricarboxylic acids are preferably citric acid or trimellitic acid. The stated acids may be used individually or as mixtures of two or more thereof. Particularly suitable in the context of the invention are polyester polyols formed from at least one of the stated dicarboxylic acids and glycerol, with a residual OH group content.

The polyesters may where appropriate have a low fraction of carboxyl end groups. Polyesters obtainable from lactones, on the basis for example of ε-caprolactone, also called “polycaprolactones” or hydroxycarboxylic acids, ω-hydoxycaproic acid for example, may likewise be employed. It is, however, also possible to use polyester polyols of oleochemical origin. Polyester polyols of this kind can be prepared, for example, by complete ring opening of epoxidized triglycerides of a fatty mixture at least partly comprising olefinically unsaturated fatty acid with one or more alcohols having 1 to 12 C atoms and subsequent partial transesterification of the triglyceride derivatives to form alkyl ester polyols having 1 to 12 C atoms in the alkyl radical. Further suitable polyols are polycarbonate polyols and dimer diols (Henkel) and also castor oil and its derivatives. The hydroxy-functional polybutadienes, of the kind obtainable under the trade name “Poly-bd”, for example, can also be used as polyols for the compositions of the invention.

Likewise suitable as the polyol component are polyacetals. By polyacetals are meant compounds of the kind obtainable from glycols, examples being diethylene glycol or hexanediol or a mixture thereof, with formaldehyde. Polyacetals which can be used in the context of the invention may likewise be obtained by polymerizing cyclic acetals.

Of further suitability as polyols are polycarbonates. Polycarbonates can be obtained, for example, by the reaction of diols, such as propylene glycol, butane-1,4-diol or hexane-1,6-diol, diethylene glycol, triethylene glycol or tetraethylene glycol, or mixtures of two or more thereof, with diaryl carbonates, diphenyl carbonate for example, or phosgene.

Likewise suitable as the polyol component are polyacrylates which carry OH groups. These polyacrylates are obtainable, for example, by the polymerization of ethylenically unsaturated monomers which carry an OH group. Monomers of this kind are obtainable, for example, through the esterification of ethylenically unsaturated carboxylic acids and difunctional alcohols, the alcohol generally being present in a slight excess. Ethylenically unsaturated carboxylic acids suitable for this purpose are, for example, acrylic acid, methacrylic acid, crotonic acid or maleic acid. Corresponding esters which carry OH groups are, for example, 2-hydroxyethyl acrylate, 2-hydroxyethyl methacrylate, 2-hydroxypropyl acrylate, 2-hydroxypropyl acrylate, 2-hydroxypropyl methacrylate, 3-hydroxypropyl acrylate or 3-hydroxypropyl methacrylate, or mixtures of two or more thereof.

As the polyol in the first synthesis stage use is made of at least one polyol having an average molecular weight (Mₙ) of 60 to 3000 g/mol, preferably 100 to 2000 g/mol, and with particular preference 200 to 1200 g/mol. Particular preference is given to using in the first synthesis stage at least one polyether polyol having a molecular weight (Mₙ) of 100 to 3000 g/mol, preferably 150 to 2000 g/mol, and/or at least one polyester polyol having a molecular weight of 100 to 3000 g/mol, preferably 250 to 2500 g/mol.

In a further preferred embodiment the first synthesis stage uses at least one polyol which possesses hydroxyl groups differing in reactivity. A difference in reactivity exists, for example, between primary and secondary hydroxyl groups. Specific examples of the polyols for inventive use which have hydroxyl groups of different reactivity are 1,2-propanediol, 1,2-butanediol, dipropylene glycol, tripropylene glycol, tetrapropylene glycol, the higher homologs of polypropylene glycol having an average molecular weight (number average Mₙ) of up to 3000, in particular up to 2500 g/mol, and also copolymers of polypropylene glycol, examples being block copolymers or random copolymers of ethylene oxide and propylene oxide.

By reaction of polyisocyanate (X) with a polyol having an average molecular weight of 60 to 3000 g/mol, component (A) is prepared in the first synthesis stage, the ratio of hydroxyl groups to isocyanate groups being set so as to result in a product which is still fluid at least at reaction temperature. Component (A) is of sufficiently low viscosity if the ratio of hydroxyl groups to isocyanate groups is set <1, preferably in the range 0.4:1 to 0.8:1, and with particular preference 0.45:1 to 0.6:1.

For implementing the process of the invention it is preferred if, in the first synthesis stage, the reaction of polyisocyanate (X) with the at least one polyol having an average molecular weight (Mₙ) of 60 to 3000 g/mol takes place at a temperature of 20° C. to 90° C., preferably of 40 to 85° C., with particular preference of 60 to 80° C. In one particular embodiment the reaction in the first synthesis stage takes place at 35 to 50° C. or at room temperature. It is important to continue the reaction in the first synthesis stage until all of the hydroxyl groups have undergone reaction. For this purpose the critical figure is the calculated NCO value, which comes about theoretically on complete reaction of the hydroxyl groups with the more reactive NCO group of polyisocyanate (X). In practice this can be ascertained analytically by titrating the isocyanate groups, and the second synthesis stage is initiated when the calculated NCO figure has been reached. The reaction time is dependent on the temperature. At 40° C. to 75° C. the reaction time is 2 to 20 hours. At room temperature the reaction time is 2 to 5 days.

Component (A) has an NCO figure of 4% to 16%, preferably 4% to 12%, and with particular preference 4% to 10%, by weight (by the method of Spiegelberger, EN ISO 11909).

In one particularly preferred embodiment of the invention the reaction mixture of the first and/or second synthesis stage comprises a catalyst. Suitable catalysts for possible use in accordance with the invention include phosphoric acid, organometallic compounds and/or tertiary amines in concentrations between 0.1% and 5% by weight, preferably between 0.3% and 2% by weight, and with particular preference between 0.5% to 1% by weight. Preference is given to organometallic compounds of tin, iron, titanium, bismuth or zirconium. Particular preference is given to organometallic compounds such as tin(II) salts or titanium(IV) salts of carboxylic acids, strong bases such as alkali metal hydroxides, alkoxides, and phenoxides, examples being di-n-octyltin mercaptide, dibutyltin maleate, diacetate, dilaurate, dichloride, bisdodecyl-mercaptide, tin(II) acetate, ethylhexoate, and diethylhexoate, tetraisopropyl titanate or lead phenylethyl dithiocarbamate.

In particular the following tertiary amines are used as catalyst, alone or in combination with at least one of the abovementioned catalysts: diaza-bicyclooctane (DABCO), triethylamine, dimethylbenzylamine (DESMORAPID DB, Bayer).

In accordance with the invention, combinations of organometallic compounds and amines are particularly preferred, the ratio of amine to organometallic compound being 0.5:1 to 10:1, preferably 1:1 to 5:1, and with particular preference 1.5:1 to 3:1.

In one particularly preferred embodiment of the invention, particularly for the purpose of raising the selectivity, i.e., of increasing the preferred reaction of one of the two NCO groups of the polyisocyanate (X) in the first synthesis stage, ε-caprolactam is used as catalyst. Relative to the total amount of polyisocyanate (X) and polyol employed in the first synthesis stage, the amount of ε-caprolactam employed is 0.05% to 6% by weight, preferably 0.1% to 3% by weight, with particular preference 0.2% to 0.8% by weight. The ε-caprolactam can be used as a powder, as granules or in liquid form.

In the second synthesis stage, as further polyol, it is preferred to use a polyether or polyether mixture having a molecular weight (Mₙ) of about 100 to 10 000 g/mol, preferably of about 200 to about 5000 g/mol, and/or a polyester polyol or polyester polyol mixture having a molecular weight (Mₙ) of about 200 to 10 000 g/mol.

In one particularly preferred embodiment of the invention, in the second synthesis stage, as further polyol, a polyol having a molecular weight (Mₙ) of 60 to 400, preferably 80 to 200 g/mol is used.

In the second synthesis stage the ratio of hydroxyl groups to isocyanate groups of component (A) is 1.1:1 to 2:1, preferably 1.3:1 to 1.8:1, and with particular preference from 1.45:1 to 1.75:1.

For the reaction over all synthesis stages the overall ratio of NCO groups to hydroxyl groups is 1.6 to 1.8:1.

In one preferred embodiment of the process of the invention, in the second synthesis stage, the at least one further polyol is added at a temperature of between 25° C. to 100° C., preferably between 35° C. to 85° C., with particular preference between 45 and 70° C., and said further polyol is caused to react with the isocyanate groups of component (A) and any excess polyisocyanate (X) still present until the number of isocyanate groups does not fall further. This can be ascertained analytically by titrating the isocyanate groups.

The monomeric 2,4-TDI and 2,4′-MDI content at the end of the second stage is less than 0.5% by weight, preferably less than 0.1% by weight, based on the total weight of component (A).

In one particularly preferred embodiment of the invention, in a third synthesis stage at the end of the second synthesis stage, at least one further at least difunctional polyisocyanate is added.

In one particular embodiment the synthesis is carried out in an aprotic solvent. The aprotic solvent used preferably comprises halogenated organic solvents, particular preference being given to using acetone, methyl ethyl ketone, methyl isobutyl ketone or ethyl acetate.

The ponderal fraction of the overall reaction mixture in the mixture with the aprotic solvent is 30% to 90% by weight, preferably 40% to 85% by weight, and with particular preference 60% to 80% by weight. The end product is preferably a solvent-free polyurethane prepolymer, and therefore, after the end of the reaction and after a subsequent stirring period of 30 to 90 minutes, the solvent is removed by distillation.

The polyurethane prepolymer of the invention having terminal NCO groups has at 40° C. a viscosity of 800 mPas to 10 000 mPas, preferably of 1000 mPas to 5000 mPas, and with particular preference of 1200 mPas to 3000 mPas (measured by the Brookfield method, ISO 2555).

The NCO content of the inventively prepared polyurethane prepolymer is 6% to 22% by weight and with particular preference 8% to 15% by weight (by the method of Spiegelberger, EN ISO 11909).

The polyurethane prepolymers of the invention having terminal isocyanate groups, in bulk (without solvent) or as a solution in organic solvents, are suitable as adhesives/sealants or adhesive/sealant components, preferably for producing one-component or two-component adhesives/sealants. Owing to the extremely low proportion of migratable monomeric asymmetric diisocyanates, particularly the volatile 2,4-TDI, the inventively prepared polyurethane prepolymers are especially suitable as one-component or two-component laminating adhesives for laminating textiles, metals, especially aluminum, and polymeric films, and also metal vapor coated and/or oxide vapor coated films and papers. In this context it is possible to add customary curing agents, such as polyfunctional polyols of relatively high molecular weight (two-component systems), or else to carry out direct bonding of surfaces of defined moisture content using the inventively produced products (one-component adhesives).

The inventively prepared polyurethane prepolymers are notable for an extremely low fraction of monomeric volatile diisocyanates having a molecular weight of below 500 g/mol, which are objectionable from the standpoint of occupational hygiene. The process has the economic advantage that the low monomer content is achieved without costly and inconvenient worksteps.

The polyurethane prepolymers thus prepared are free, furthermore, from the byproducts typically obtained in the case of thermal work-up steps, such as crosslinking products or depolymerization products.

The process of the invention achieves shorter reaction times and yet leaves the selectivity between the different NCO groups of the asymmetric diisocyanate intact to the extent that polyurethane prepolymers having low viscosities are obtained. As a result of this the adhesive bonding of temperature-sensitive substrates, particularly of polymeric films, is made possible. The group of temperature-sensitive polymeric films includes polyolefin films, especially films of polyethylene or polypropylene.

Film laminates produced on the basis of the inventively prepared polyurethane prepolymers exhibit high processing reliability on hot sealing. This can be attributed to the sharply reduced fraction of migratable products of low molecular weight in the polyurethane.

As a result of the sharply reduced fraction of migratable products of low molecular weight, the polyurethane prepolymers of the invention are suitable in particular for producing film laminates for the comestibles sector. The invention accordingly further provides film laminates, particularly for the packaging of comestibles, which comprise laminating adhesives based on the polyurethane prepolymers of the invention. Furthermore, the inventively prepared, low monomer content polyurethane prepolymers, containing NCO groups, can also be used in extrusion primers, print primers, and metallization primers, and also for hot sealing.

The invention is now elucidated in detail with reference to examples.

### EXAMPLES

### 1. Formula Examples

### 1.1 Example 1

21.9% trifunctional polyester polyol with OH number of 160
21.0% polypropylene glycol with OH number of 110
1.4% diethylene glycol (DEG)
19.6% DESMODUR T-100 (Bayer AG)
36.2% ISONATE M143 (modified 4,4′-MDI with an about 20% carbodiimide fraction; Dow Chemical Company)

The mixture of trifunctional polyol and PPG is reacted with TDI at 75 to 80° C. until OH has undergone full reaction (8% by weight NCO). Cooling is carried out to about 60° C. and DEG is slowly added dropwise. At this temperature the full reaction of the DEG takes place to constant NCO level (6% by weight NCO). In the cooling phase the liquid MDI oligomer Isonate is added and an NCO figure of 14.2% by weight is set.
viscosity: 7300 mPas (Brookfield, LVT) at 20° C.
   2400 mPas (Brookfield, LVT) at 40° C.
free TDI: <0.1% by weight

The 2-component laminating adhesive is obtained by mixing the above PU prepolymer with a polyester-based curing agent (functionality 2-3, OH number 170, viscosity <10 000 mPas at RT) in a ratio of 1.25:1.

### 1.2. Example 2 (Comparative)

In the formula of example 1, the only change is that DESMODUR T-100 is replaced with T-80/20.
viscosity: 11,750 mPas (Brookfield, LVT) at 20° C.
   2200 mPas (Brookfield, LVT) at 40° C.
free TDI: 0.3-0.5% by weight

Laminating adhesive in combination with curing agent (see Ex. 1) in comparison 1.25:1.

3. Results

The composite and seal adhesion values after 14 days of curing are given in Table 1. The migrant levels over time are given in Table 2. Table 3 reproduces the migrant levels of inventive example 1 in comparison to example 2.

TABLE 1

| | Inventive | | System with |
|---|---|---|---|
| | system: | Conventional | multistage |
| | as per | two-component | curing |
| Composite | Example 1 | PU system¹⁾ | mechanism²⁾ |
| OPP/PE composite | 4.8 Coex | 3.6 Coex | 3.2 Coex |
| adhesion [N/15 mm] | rupture | rupture | rupture |
| OPP/PE sealed | 38 composite | 36 composite | 38 composite |
| seam adhesion | fracture | fracture | fracture |
| [N/15 mm] | | | |
| PETmet/CPP composite | 1.5 adhesive | 1.2 adhesive | 1.2 adhesive |
| adhesion | to CPP | to CPP | to CPP |
| [N/15 mm] | | | |
| PETmet//CPP sealed | 27 composite | 34 composite | 24 composite |
| seam adhesion | fracture | fracture | fracture |
| [N/15 mm] | | | |

¹⁾LIOFOL UR 7725/curing agent UR 6062-21, MR:170:100
²⁾LIOFOL UR 7735/curing agent UR 6088, MR:100:40

TABLE 2

| | Migrant values¹⁾ | | |
|---|---|---|---|
| Cure time | Inventive | | System with |
| in days | system: | Conventional two- | multistage |
| after | as per | component PU | curing |
| lamination | Example 1 | system²⁾ | mechanism³⁾ |
| 1 | 34 | 83 | 22 |
| 2 | 7 | 67 | 5 |
| 3 | 6 | 66 | 3 |
| 7 | 1.1 | 22 | 1.26 |

¹⁾Migrant levels by BGVV method, μg aniline hydrochloride/100 ml
²⁾LIOFOL UR 7725/curing agent UR 6062-21, MR:170:100
³⁾LIOFOL UR 7735/curing agent UR 6088, MR:100:40

TABLE 3

Migrant values¹⁾

| | | System according |
|---|---|---|
| Cure time in days | Inventive system: | to comparative |
| after lamination | as per Example 1 | Example 2 |
| 1 | 30 | 56 |
| 4 | 3 | 6 |
| 7 | 0.32 | 1.55 |
| 11 | not detectable | 0.63 |
| | (<0.2) | |
| 14 | not detectable | 0.44 |
| | (<0.2) | |

¹⁾Migrant levels by BGVV method, μg aniline hydrochloride/100 ml

What is claimed is:

1) A process for preparing a polyurethane prepolymer having terminal isocyanate groups by reacting polyisocyanates with polyols, said process comprising:
(I) preparing in a first synthesis stage a component (A)
a) using as polyisocyanate (X) at least one asymmetric polyisocyanate;
b) using as polyol at least one polyol having an average molecular weight (Mₙ) of 60 to 3000 g/mol;
c) setting the ratio of hydroxyl groups to isocyanate groups <1;
d) adding, optionally, a catalyst; and, following the reaction of all of the hydroxyl groups;
(II) in a second synthesis stage, adding at least one further polyol to component (A), the reaction ratio of the hydroxyl groups of the at least one further polyol to isocyanate groups of component (A) being set in the range from 1.1:1 to 2.0:1.

2) The process of claim 1, additionally comprising a third synthesis stage wherein at least one further at least difunctional polyisocyanate is added.

3) The process of claim 1, wherein at least one polyol having an average molecular weight (Mₙ) of 200 to 1200 g/mol is used in the first synthesis stage.

4) The process of claim 1, wherein at least one polyol selected from the group consisting of polyether polyols having molecular weights (Mₙ) of 100 to 3000 g/mol and polyester polyols having molecular weights (Mₙ) of 100 to 3000 g/mol is used in the first synthesis step.

5) The process of claim 1, wherein ε-caprolactam is used as catalyst.

6) The process of claim 1, wherein a polyol having a molecular weight (Mₙ) of 60 to 400 is used in the second synthesis stage.

7) The process of claim 1, wherein a polyol selected from the group consisting of polyether polyols having molecular weights of 100 to 10,000 g/mol and polyester polyols having molecular weights of 200 to 10,000 g/mol is used in the second synthesis step.

8) The process of claim 2, wherein, as further polyisocyanate, an at least trifunctional isocyanate is added in the third synthesis stage.

9) The process of claim 2, wherein, as further polyisocyanate, a mixture of a diisocyanate with carbodiimide is added in the third synthesis stage.

10) The process of claim 1, wherein said at least one asymmetric polyisocyanate is selected from the group consisting of TDI having a 2,4-TDI content ≧99% by weight and diphenylmethane 2,4-diisocyanate having a 2,4′ isomer fraction of at least 95% by weight.

11) The process of claim 1, wherein the ratio of hydroxyl groups to isocyanate groups in the first synthesis stage is set in the range between 0.45:1 to 0.6:1.

12) The process of claim 1, wherein the ratio of hydroxyl groups to isocyanate groups in the first synthesis stage is set in the range between 0.4:1 to 0.8:1.

13) The process of claim 1, wherein the reaction ratio of the hydroxyl groups of the at least one further polyol to isocyanate groups of component (A) in the second synthesis stage is set in the range from 1.3:1 to 1.8:1.

14) The process of claim 1, wherein the reaction ratio of the hydroxyl groups of the at least one further polyol to isocyanate groups of component (A) in the second synthesis stage is set in the range from 1.45:1 to 1.75:1.

15) A polyurethane prepolymer having terminal isocyanate groups, obtained by the process of claim 1.

16) The polyurethane prepolymer having terminal isocyanate groups of claim 15, wherein said polyurethane prepolymer has a monomeric 2,4-TDI, 2,4′-MDI content of less than 1% by weight.

17) The polyurethane prepolymer having terminal isocyanate groups of claim 16, having at 40° C. a viscosity of 800 mPas to 10,000 mPas (measured by the Brookfield method, ISO 2555).

18) A film laminate comprising a first film adhered to a second film by a laminating adhesive, wherein said laminating adhesive is comprised of a polyurethane prepolymer produced by the process of claim 1.

19) The film laminate of claim 18, wherein said laminating adhesive is additionally comprised of at least one curing agent.

20) The film laminate of claim 18, wherein said laminating adhesive is additionally comprised of at least one curing agent selected from the group consisting of polyfunctional polyols.

21) A process for preparing a polyurethane prepolymer having terminal isocyanate groups by reacting polyisocyanates with polyols, said process comprising:
(I) preparing in a first synthesis stage a component (A)
a) using as polyisocyanate (X) at least one asymmetric polyisocyanate selected from the group consisting of TDI having a 2,4-TDI content ≧99% by weight and diphenylmethane 2,4-diisocyanate having a 2,4′ isomer fraction of at least 95% by weight;
b) using as polyol at least one polyol selected from the group consisting of polyether polyols having molecular weights (Mₙ) of 100 to 3000 g/mol and polyester polyols having molecular weights (Mₙ) of 100 to 3000 g/mol;
c) setting the ratio of hydroxyl groups to isocyanate groups within the range 0.4:1 to 0.8:1;
d) adding, optionally, a catalyst, and, following the reaction of all of the hydroxyl groups;
(II) in a second synthesis stage, adding at least one further polyol to component (A), the reaction ratio of the hydroxyl groups of the at least one further polyol to isocyanate groups of component (A) being set in the range from 1.3:1 to 1.8:1 and the at least one further polyol having a number average molecular weight of 60 to 400 g/mol; and
(III) in a third synthesis step, adding at least one further at least difunctional polyisocyanate.

22) A process for preparing a polyurethane prepolymer having terminal isocyanate groups by reacting polyisocyanates with polyols, said process comprising:
(I) preparing in a first synthesis stage a component (A)
a) using as polyisocyanate (X) at least one asymmetric polyisocyanate selected from the group consisting of TDI having a 2,4-TDI content ≧99% by weight and diphenylmethane 2,4-diisocyanate having a 2,4′ isomer fraction of at least 97% by weight;
b) using as polyol at least one polyether polyol having a molecular weight (Mₙ) of 150 to 2000 g/mol and at least one polyester polyol having a molecular weight (Mₙ) of 250 to 2500 g/mol;
c) setting the ratio of hydroxyl groups to isocyanate groups within the range 0.45:1 to 0.6:1;
d) adding, optionally, a catalyst, and, following the reaction of all of the hydroxyl groups;
(II) in a second synthesis stage, adding at least one further polyol to component (A), the reaction ratio of the hydroxyl groups of the at least one further polyol to isocyanate groups of component (A) being set in the range from 1.45:1 to 1.75:1 and the at least one further polyol having a number average molecular weight of 80 to 200 g/mol;
(III) in a third synthesis step, adding at least one further at least difunctional polyisocyanate containing carbodiimide
